(19) United States
(12) Patent Application Publication
(10) Pub. No.: US 2025/0253721 A1
(43) Pub. Date: Aug. 7, 2025

(54) ELECTRIC MOTOR HAVING A STATOR INCLUDING A COOLING FLUID TURBULATOR SYSTEM

(71) Applicant: GM Global Technology Operations LLC, Detroit, MI (US)

(72) Inventor: Mark R. Claywell, Birmingham, MI (US)

(21) Appl. No.: 18/432,540

(22) Filed: Feb. 5, 2024

(51) Int. Cl. H02K 1/20; H02K 7/00

(52) U.S. Cl. CPC H02K 1/20; H02K 7/006

(57) ABSTRACT

A stator includes a plurality of stator laminations having an axial axis. The plurality of stator laminations include a coolant passage extending along the axial axis. The plurality of stator laminations include a first stator lamination including a first plurality of openings. The first plurality of openings define a first portion of the coolant passage. The plurality of stator laminations include a second stator lamination including a second web and a second plurality of openings. The second plurality of openings defining a second portion of the coolant passage. The first stator lamination is stacked upon the second stator lamination with each of the first plurality of openings being offset relative to corresponding ones of the second plurality of openings such that in each of the first plurality of openings, a portion of the second web and a portion of the corresponding one of the second plurality of openings are exposed.

### INTRODUCTION

The subject disclosure relates to the art of vehicles and, more particularly, to a vehicle including an electric motor having a stator provided with a cooling fluid turbulator system.

Electric motors convert electrical energy into mechanical output. Electrical energy is delivered into a stator supporting a plurality of windings. The electrical energy flowing through the windings produces a magnetic field that acts on a rotor to create rotational energy. The flow of electrical energy and the generation of the magnetic field, coupled with the rotation of the rotor in the stator, create heat. Energy that creates the heat is not used to create the rotational energy and thus reduces an overall efficiency of the electric motor.

There are a wide array of systems for cooling electric motors. Rotors maybe outfitted with fans that either drive air through, or pull air into the electric motor. Cooling fluid, such as a liquid coolant, may be directed into a motor housing and through passages formed in the stator. The cooling fluid may be passed through a heat exchanger and recycled through the motor. In many cases, the liquid coolant is directed into a center portion of the stator and allowed to flow axially outwardly in two directions. While each method is effective at reducing motor temperature, improvements in motor cooling are always welcome. Accordingly, it is desirable to provide a system that enhances thermal exchange between the stator and the cooling fluid.

### SUMMARY

A stator for an electric machine, in accordance with a non-limiting example, includes a plurality of stator laminations defining a stator core having an axial axis. The plurality of stator laminations include a circumference, a radius, and a coolant passage extending along the axial axis. The plurality of stator laminations include a first stator lamination including a first web and a first plurality of openings extending through the first web spaced about the circumference. The first plurality of openings define a first portion of the coolant passage. The plurality of stator laminations include a second stator lamination including a second web and a second plurality of openings extending through the second web spaced about the circumference. The second plurality of openings defining a second portion of the coolant passage. The first stator lamination is stacked upon the second stator lamination with each of the first plurality of openings being offset relative to corresponding ones of the second plurality of openings along one of the circumference and the radius such that in each of the first plurality of openings, a portion of the second web and a portion of the corresponding one of the second plurality of openings are exposed.

In addition to one or more of the features described herein the plurality of stator laminations includes a third stator lamination, including a third web and a third plurality of openings extending through the third web spaced about the circumference, the third plurality of openings defining a third portion of the coolant passage.

In addition to one or more of the features described herein the third stator lamination is stacked upon the second stator lamination with each of the third plurality of openings being offset relative to corresponding ones of the second plurality of openings along one of the circumference and the radius such that in each of the third plurality of openings, a portion of the second web and a portion of the corresponding one of the first plurality of openings and the second plurality of openings are exposed.

In addition to one or more of the features described herein each of the third plurality of openings are substantially aligned with corresponding ones of the first plurality of openings.

In addition to one or more of the features described herein the plurality of stator laminations includes a fourth stator lamination, including a fourth web and a fourth plurality of openings extending through the fourth web spaced about the circumference, the fourth plurality of openings defining a fourth portion of the coolant passage.

In addition to one or more of the features described herein the fourth stator lamination is stacked upon the third stator lamination with each of the fourth plurality of openings being offset relative to corresponding ones of the third plurality of openings along one of the circumference and the radius such that in each of the fourth plurality of openings, a portion of the third web and a portion of the corresponding one of the third plurality of openings, the first plurality of openings and the second plurality of openings are exposed.

In addition to one or more of the features described herein each of the fourth plurality of openings are substantially aligned with corresponding ones of the second plurality of openings.

In addition to one or more of the features described herein the first stator lamination defines a first stator lamination group including a first number of stator laminations, the second stator lamination defines a second stator lamination group including a second number of stator laminations, the third stator lamination defines a third stator lamination group including a third number of stator laminations, and the fourth stator lamination defines a fourth stator lamination group including a fourth number of stator laminations.

In addition to one or more of the features described herein the second number of stator laminations is less than the first number of stator laminations, the third number of stator laminations is less than the second number of stator laminations, and the fourth number of stator laminations are less than the third number of stator laminations.

In addition to one or more of the features described herein the stator includes a first axial end, a second axial end, and a central portion having a coolant inlet fluidically connected to the coolant passage, the first stator lamination group being arranged at the coolant inlet, the second stator lamination group being arranged directly adjacent to the first stator lamination group, the third stator lamination group being arranged directly adjacent the second stator lamination group, and the fourth stator lamination group being arranged at one of the first axial end and the second axial end.

A vehicle, in accordance with a non-limiting example, includes a body including a passenger compartment, a rechargeable energy storage system (RESS) supported by the body, and an electric drive unit arranged in the body and operatively connected to the RESS. The electric drive unit includes a housing having an inner surface, a stator fixedly mounted to the inner surface, and a rotor rotatably supported within the stator. The stator includes a plurality of stator laminations defining a stator core having an axial axis. The plurality of stator laminations include a circumference, a radius, and a coolant passage extending along the axial axis. The plurality of stator laminations includes a first stator lamination including a first web and a first plurality of openings extending through the first web spaced about the circumference, the first plurality of openings defining a first portion of the coolant passage. The plurality of stator laminations include a second stator lamination including a second web and a second plurality of openings extending through the second web spaced about the circumference. The second plurality of openings define a second portion of the coolant passage. The first stator lamination is stacked upon the second stator lamination with each of the first plurality of openings being offset relative to corresponding ones of the second plurality of openings along one of the circumference and the radius such that in each of the first plurality of openings, a portion of the second web and a portion of the corresponding one of the second plurality of openings are exposed.

In addition to one or more of the features described herein the plurality of stator laminations includes a third stator lamination, including a third web and a third plurality of openings extending through the third web spaced about the circumference, the third plurality of openings defining a third portion of the coolant passage.

In addition to one or more of the features described herein the third stator lamination is stacked upon the second stator lamination with each of the third plurality of openings being offset relative to corresponding ones of the second plurality of openings along one of the circumference and the radius such that in each of the third plurality of openings, a portion of the second web and a portion of the corresponding one of the first plurality of openings and the second plurality of openings are exposed.

In addition to one or more of the features described herein each of the third plurality of openings are substantially aligned with corresponding ones of the first plurality of openings.

In addition to one or more of the features described herein the plurality of stator laminations includes a fourth stator lamination, including a fourth web and a fourth plurality of openings extending through the fourth web spaced about the circumference, the fourth plurality of openings defining a fourth portion of the coolant passage.

In addition to one or more of the features described herein the fourth stator lamination is stacked upon the third stator lamination with each of the fourth plurality of openings being offset relative to corresponding ones of the third plurality of openings along one of the circumference and the radius such that in each of the fourth plurality of openings, a portion of the third web and a portion of the corresponding one of the third plurality of openings, the first plurality of openings and the second plurality of openings are exposed.

In addition to one or more of the features described herein each of the fourth plurality of openings are substantially aligned with corresponding ones of the second plurality of openings.

In addition to one or more of the features described herein the first stator lamination defines a first stator lamination group including a first number of stator laminations, the second stator lamination defines a second stator lamination group including a second number of stator laminations, the third stator lamination defines a third stator lamination group including a third number of stator laminations, and the fourth stator lamination defines a fourth stator lamination group including a fourth number of stator laminations.

In addition to one or more of the features described herein the second number of stator laminations is less than the first number of stator laminations, the third number of stator laminations is less than the second number of stator laminations, and the fourth number of stator laminations are less than the third number of stator laminations.

In addition to one or more of the features described herein the stator includes a first axial end, a second axial end, and a central portion having a coolant inlet fluidically connected to the coolant passage, the first stator lamination group being arranged at the coolant inlet, the second stator lamination group being arranged directly adjacent to the first stator lamination group, the third stator lamination group being arranged directly adjacent the second stator lamination group, and the fourth stator lamination group being arranged at one of the first axial end and the second axial end.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including an electric drive unit having a stator including a cooling fluid turbulator system, in accordance with a non-limiting example;

FIG. 2 is a cross-sectional side view of an electric motor portion of the electric drive unit including a stator having a cooling fluid turbulator system, in accordance with a non-limiting example;

FIG. 3 is a view of a portion of a stator of the electric motor portion of the electric drive unit of FIG. 2 taken at line 3-3, in accordance with a non-limiting example;

FIG. 4 is a partially disassembled view of the stator of FIG. 3, in accordance with a non-limiting example;

FIG. 5 is a partially cut-away view of the stator of the electric motor portion of the electric drive unit of FIG. 2, in accordance with a non-limiting example;

FIG. 6 is a cut away view of the stator of the electric motor portion of the electric drive unit of FIG. 2 depicting a cooling fluid turbulator system, in accordance with a non-limiting example;

FIG. 7 is a cut away view of the stator of the electric motor portion of the electric drive unit of FIG. 2 depicting a cooling fluid turbulator system, in accordance with another non-limiting example; and

FIG. 8 is a cut away view of the stator of the electric motor portion of the electric drive unit of FIG. 2 depicting a cooling fluid turbulator system, in accordance with yet another non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

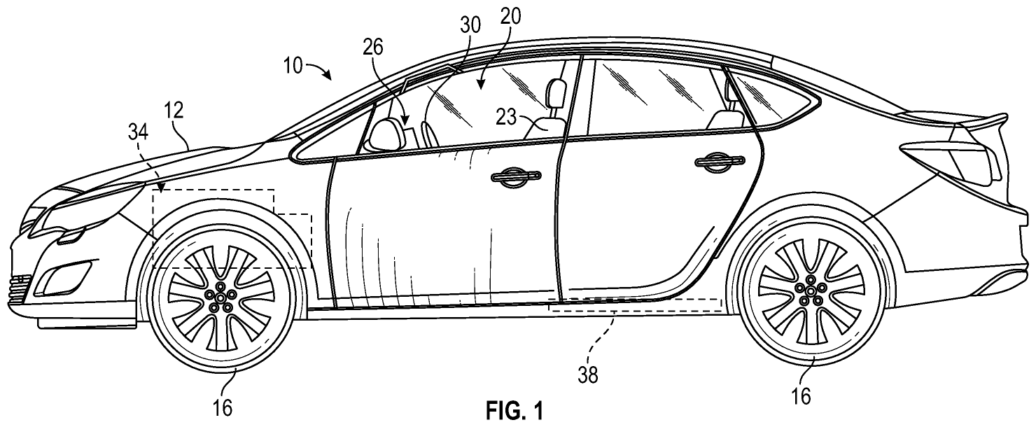

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of select ones of the plurality of wheels 16. Vehicle 10 includes an electric machine shown in the form of an electric drive unit 34 that provides power to one or more of the plurality of wheels 16.

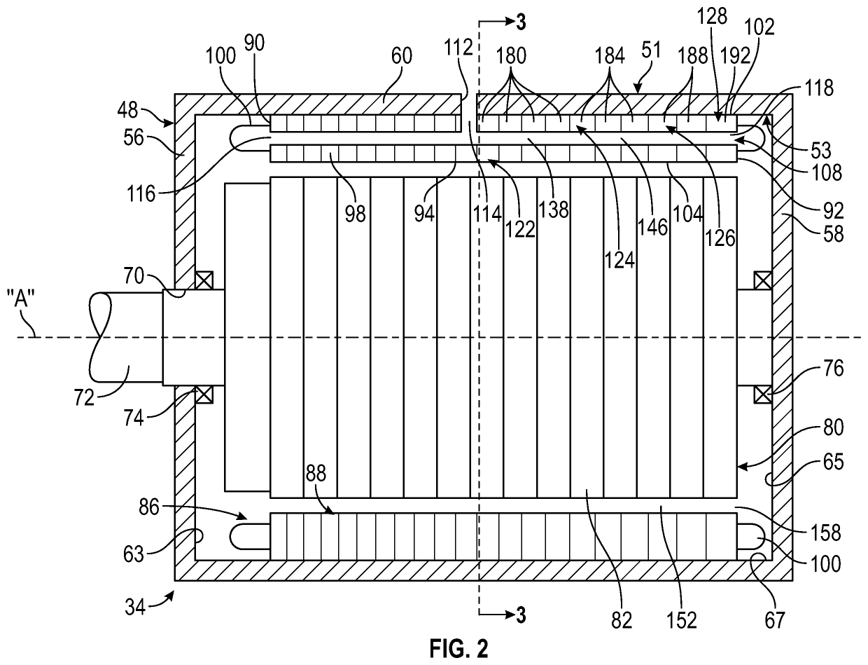

A rechargeable energy storage system (RESS) or battery assembly 38 is arranged in body 12 and provides power to electric drive unit 34. At this point, it should be understood that the location of electric drive unit 34 and battery assembly 38 may vary. Reference will now follow to FIG. 2 in describing electric drive unit 34 in accordance with a non-limiting example. Electric drive unit 34 includes a housing 48 having an outer surface 51 and an inner surface 53. Housing 48 includes a first axial end wall 56, a second axial end wall 58, and an intermediate wall 60 that extends between and connects with first axial end wall 56 and second axial end wall 58. Inner surface 53 includes a first axial end surface 63 associated with first axial end wall 56, a second axial end surface 65 associated with second axial end wall 58. Housing 48 also includes an annular inner surface 67 associated with intermediate wall 60.

First axial end wall 56 includes an opening 70 that accommodates a rotor shaft 72 that extends into and through housing 48. Rotor shaft 72 defines a rotor or axial axis “A” that extends through housing 48. Rotor shaft 72 is supported at first axial end wall 56 by a first bearing 74. Rotor shaft 72 is supported at second axial end wall 58 by a second bearing 76. Rotor shaft 72 supports a rotor 80 formed from a plurality of rotor laminations 82.

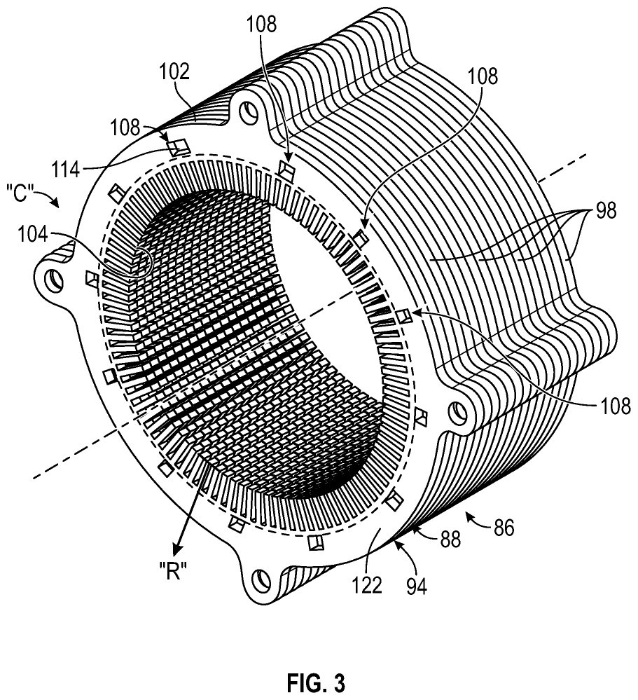

In a non-limiting example, a stator 86 is mounted to annular inner surface 67. Stator 86 extends about rotor 80 and includes a stator core 88 having a first axial end 90, a second axial end 92 that is opposite first axial end 90. Stator core 88 is further shown to include a central portion 94. First axial end 90 is spaced from first axial end wall 56 and second axial end 92 is spaced from second axial end wall 58. Stator core 88 is formed from a plurality of stator laminations 98 that support stator windings 100. Stator core 88 includes an outer surface 102 and an inner surface 104. Outer surface 102 defines a circumference “C” of stator core 88 (FIG. 3). A radius “R” of stator core 88 is defined between inner surface 104 and outer surface 102. Electric energy, supplied by RESS 38 is passed though stator windings 100 to induce a magnetic field in rotor 80. The magnetic field interacts with magnetic poles (not shown) or a rotor winding (also not shown) supported by rotor laminations 82 causing rotor 80 to rotate about axis “A” and deliver drive energy to select ones of the plurality of wheels 16.

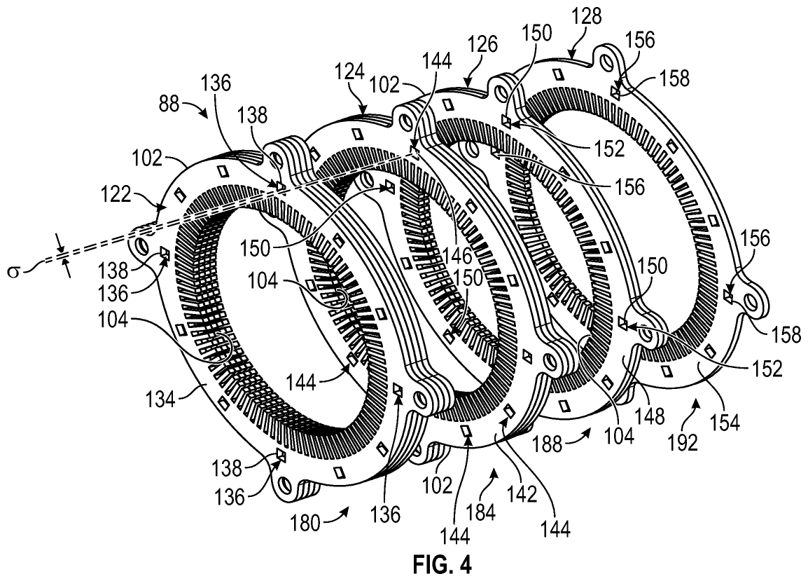

In a non-limiting example, illustrated in FIGS. 3 and 4 and with continued reference to FIG. 2, stator core 88 includes a plurality of coolant passages 108 that extend through stator laminations 98 between first axial end 90 and second axial end 92. The number of coolant passages 108 may vary. Further, coolant passages 108 may form an annular ring about stator core 88. In a non-limiting example, housing 48 includes an opening 112 (FIG. 2) formed in intermediate wall 60. The plurality of coolant passages 108 include a coolant inlet 114 in central portion 94 fluidically connected to opening 112, a first outlet 116 defined at first axial end 90 and a second outlet 118 defined at second axial end 92. Cooling fluid or coolant is passed through opening 112 into each of the plurality of coolant passages 108. The coolant flows axially outwardly toward first outlet 116 and second outlet 118 and collects in housing 48. The coolant may then be passed through a heat exchanger (not shown) and reintroduced into stator 86 via opening 112.

In a non-limiting example illustrated in FIG. 2, stator laminations 98 include a first stator lamination 122 arranged adjacent to coolant inlet 114, a second stator lamination 124 arranged between first stator lamination 122 and second axial end 92, a third stator lamination 126 arranged between second stator lamination 124 and second axial end 92, and a fourth stator lamination 128 arranged between third stator lamination 126 and second axial end 92. Fourth stator lamination 128 may define second outlet 118 or may represent a lamination that is arranged between third stator lamination 126 and second outlet 118. At this point, it should be understood that additional ones of the plurality of stator laminations 98 of stator core 88 extend between opening 112 and first axial end 90. Further, the number of stator laminations may vary.

Referring to FIG. 4 and with continued reference to FIGS. 2 and 3, in a non-limiting example, first stator lamination 122 includes a first web 134 and a first plurality of openings 136. First plurality of openings 136 define a first portion 138 of corresponding ones of the plurality of coolant passages 108. Second stator lamination 124 includes a second web 142 having a second plurality of openings 144. Second plurality of openings 144 define a second portion 146 of corresponding ones of the plurality of coolant passages 108. Second stator lamination 124 abuts first stator lamination 122. In a non-limiting example, second stator lamination 124 is circumferentially offset relative to first stator lamination 122. In a non-limiting example, the circumferential offset may be an angle “σ” of up to about ±10°. In this manner, a portion of second web 142 is exposed in each of the first plurality of openings 136.

In a non-limiting example, third stator lamination 126 includes a third web 148 including a third plurality of openings 150. Third plurality of openings 150 form a third portion 152 of corresponding ones of the plurality of coolant passages 108. Third stator lamination 126 abuts second stator lamination 124. In a non-limiting example, third stator lamination 126 is circumferentially offset relative to second stator lamination 124. In a non-limiting example, the circumferential offset may be an angle “σ” of up to about ±10°. In this manner, a portion of third web 148 is exposed in each of the second plurality of openings 144. In a non-limiting example, third plurality of openings 150 may be substantially aligned with corresponding ones of the first plurality of openings 136. The circumferential offset may be achieved by adjusting a position of each of the plurality of opening on one or more of the plurality of laminations 88 or by clocking (rotating) one or more laminations 88 relative to others of the plurality of laminations 88.

In a non-limiting example, fourth stator lamination 128 includes a fourth web 154 having a fourth plurality of openings 156 that define a fourth portion 158 of corresponding ones of the plurality of coolant passages 108. Third stator lamination 126 abuts third stator lamination 126. In a non-limiting example, fourth stator lamination 128 is circumferentially offset relative to third stator lamination 126. In a non-limiting example, the circumferential offset may be an angle “σ” of about 10°. In this manner, a portion of fourth web 154 is exposed in each of the third plurality of openings 150. In a non-limiting example, fourth plurality of openings 156 are substantially aligned with corresponding ones of the second plurality of openings 144.

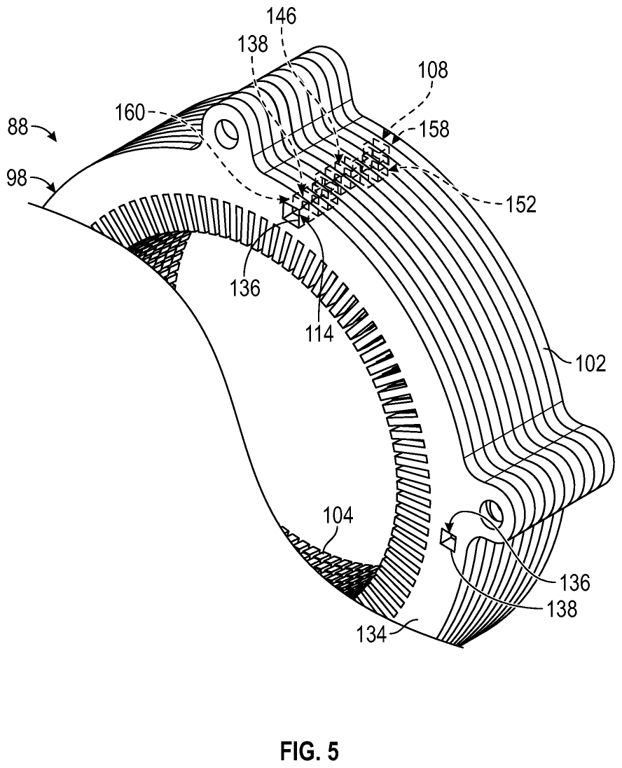

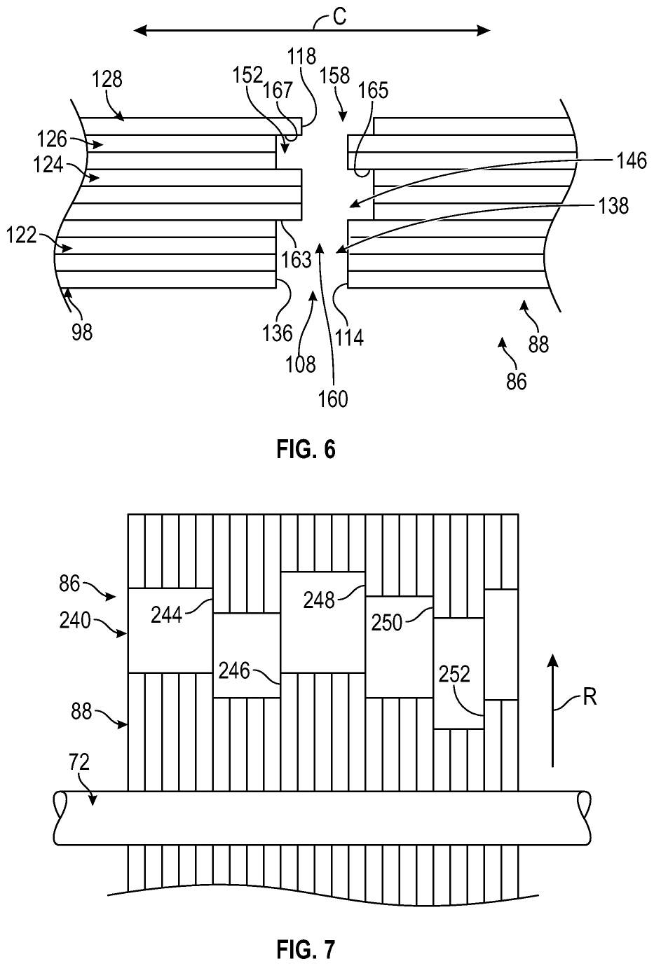

As shown in FIGS. 5 and 6 the plurality of coolant passages 108 include a cooling fluid turbulator system 160 created by the circumferential offset of second stator lamination 124 relative to first stator lamination 122 and fourth stator lamination 128 relative to third stator lamination 126. That is, the portion of second web 142 exposed through first plurality of openings 136 forms a first tripping surface 163, the portion of third web 148 exposed in each of the second plurality of openings 144 forms a second tripping surface 165, and the portion of fourth web 154 exposed in each of the third plurality of openings 150 forms a third tripping surface 167. With this arrangement, cooling fluid passing through each coolant passages 108 impacts first tripping surface 163, second tripping surface 165, and third tripping surface 167 creating localized turbulence that enhance heat transfer from stator laminations 98 into the cooling fluid. At this point it should be understood that the number, thickness, and area exposed to coolant of the tripping surfaces established in each coolant passage may vary and could be as few as a single tripping surface.

In a non-limiting example, first stator lamination 122 defines a first stator lamination group 180 formed from a first number of stator laminations 98, second stator lamination 124 defines a second stator lamination group 184 defined by a second number stator lamination 98, third stator lamination 126 defines a third stator lamination group 188 defined by a third number of stator laminations 98, and fourth stator lamination 128 defines a fourth stator lamination group 192 defined by a fourth number of stator laminations 98. In a non-limiting example, the first number of the plurality of stator laminations 98, is greater than the second number of stator laminations 98. The second number of stator laminations 98 is greater than the third number of stator laminations 98, and the third number of stator laminations 98 is greater than the fourth number of stator laminations 98.

With this construction, as the cooling fluid flows from coolant inlet 114 toward, for example, second outlet 118, cooling fluid turbulator system 160 increases turbulence in the cooling fluid. That is, when initially being introduced into coolant inlet 114, the cooling fluid is at it's lowest temperature and thus has a greater heat carrying capacity, e.g, when entering coolant passage 108. As such the need for turbulence is low. The lower turbulence leads to a lower localized heat transfer coefficient (HTC) in order to offset a higher localized temperature differential between stator core 88 and the cooling fluid so as to achieve a substantially constant temperature gradient across the plurality of stator laminations 98. As the cooling absorbs heat from the plurality of stator laminations 98, the ability to absorb more heat is diminished. Imparting turbulence at this stage increases the heat carrying/absorbing capacity of the cooling fluid. Thus, the number of laminations in each lamination group diminishes as the distance from coolant inlet 114 increases.

At this point, it should be understood that the non-limiting examples disclosed describe a system for imparting turbulence into cooling fluid passing through a stator in order to increase heat transfer. The cooling fluid passes axially through the stator hitting a number of tripping surfaces that create a localized circumferential movement of the cooling fluid to impart turbulence. The amount of turbulence imparted may vary as distance from the cooling fluid inlet increases. Further, while described as a circumferential offset of about 10°, the amount of the offset and the direction of the offset may vary. That is, instead of circumferential offsets, stator 86 may include coolant passages such as shown at 240 in FIG. 7 where tripping surfaces 244, 246, 248, 250, and 252 are formed by establishing a radial offset of openings (not separately labeled formed in stator laminations 98.

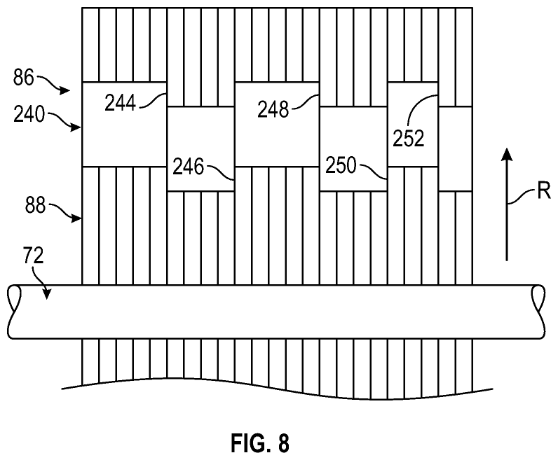

Further, it should be understood that offset(s) and corresponding tripping surface(s) may be achieved by changing a size of openings in each lamination such as shown in FIG. 8 or by alternating the geometry or shape of each opening. In such a case, the openings themselves would not be offset relative to one another but rather the offset(s) and corresponding tripping surface(s) are created through geometric changes in the openings. Thus, the term “offset” should be understood to mean shifting an orientation of openings on a lamination, rotating or clocking laminations relative to other laminations, or by changing a geometry of one or more of the plurality of openings.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A stator for an electric machine comprising:
a plurality of stator laminations defining a stator core having an axial axis, the plurality of stator laminations including a circumference, a radius, and a coolant passage extending along the axial axis,
wherein the plurality of stator laminations includes a first stator lamination including a first web and a first plurality of openings extending through the first web spaced about the circumference, the first plurality of openings defining a first portion of the coolant passage,
wherein the plurality of stator laminations includes a second stator lamination including a second web and a second plurality of openings extending through the second web spaced about the circumference, the second plurality of openings defining a second portion of the coolant passage, and
wherein the first stator lamination is stacked upon the second stator lamination with each of the first plurality of openings being offset relative to corresponding ones of the second plurality of openings along one of the circumference and the radius such that in each of the first plurality of openings, a portion of the second web and a portion of the corresponding one of the second plurality of openings are exposed.

2. The stator according to claim 1, wherein the plurality of stator laminations includes a third stator lamination, including a third web and a third plurality of openings extending through the third web spaced about the circumference, the third plurality of openings defining a third portion of the coolant passage.

3. The stator according to claim 2, wherein the third stator lamination is stacked upon the second stator lamination with each of the third plurality of openings being offset relative to corresponding ones of the second plurality of openings along one of the circumference and the radius such that in each of the third plurality of openings, a portion of the second web and a portion of the corresponding one of the first plurality of openings and the second plurality of openings are exposed.

4. The stator according to claim 3, wherein each of the third plurality of openings are substantially aligned with corresponding ones of the first plurality of openings.

5. The stator according to claim 4, wherein the plurality of stator laminations includes a fourth stator lamination, including a fourth web and a fourth plurality of openings extending through the fourth web spaced about the circumference, the fourth plurality of openings defining a fourth portion of the coolant passage.

6. The stator according to claim 5, wherein the fourth stator lamination is stacked upon the third stator lamination with each of the fourth plurality of openings being offset relative to corresponding ones of the third plurality of openings along one of the circumference and the radius such that in each of the fourth plurality of openings, a portion of the third web and a portion of the corresponding one of the third plurality of openings, the first plurality of openings and the second plurality of openings are exposed.

7. The stator according to claim 6, wherein each of the fourth plurality of openings are substantially aligned with corresponding ones of the second plurality of openings.

8. The stator according to claim 5, wherein the first stator lamination defines a first stator lamination group including a first number of stator laminations, the second stator lamination defines a second stator lamination group including a second number of stator laminations, the third stator lamination defines a third stator lamination group including a third number of stator laminations, and the fourth stator lamination defines a fourth stator lamination group including a fourth number of stator laminations.

9. The stator according to claim 8, wherein the second number of stator laminations is less than the first number of stator laminations, the third number of stator laminations is less than the second number of stator laminations, and the fourth number of stator laminations are less than the third number of stator laminations.

10. The stator according to claim 9, wherein the stator includes a first axial end, a second axial end, and a central portion having a coolant inlet fluidically connected to the coolant passage, the first stator lamination group being arranged at the coolant inlet, the second stator lamination group being arranged directly adjacent to the first stator lamination group, the third stator lamination group being arranged directly adjacent the second stator lamination group, and the fourth stator lamination group being arranged at one of the first axial end and the second axial end.

11. A vehicle comprising:
a body including a passenger compartment;
a rechargeable energy storage system (RESS) supported by the body; and
an electric drive unit arranged in the body and operatively connected to the RESS, the electric drive unit including:
a housing including an inner surface;
a stator fixedly mounted to the inner surface; and
a rotor rotatably supported within the stator, the stator comprising:
a plurality of stator laminations defining a stator core having an axial axis, the plurality of stator laminations including a circumference, a radius, and a coolant passage extending along the axial axis,
wherein the plurality of stator laminations includes a first stator lamination including a first web and a first plurality of openings extending through the first web spaced about the circumference, the first plurality of openings defining a first portion of the coolant passage,
wherein the plurality of stator laminations includes a second stator lamination including a second web and a second plurality of openings extending through the second web spaced about the circumference, the second plurality of openings defining a second portion of the coolant passage, and
wherein the first stator lamination is stacked upon the second stator lamination with each of the first plurality of openings being offset relative to corresponding ones of the second plurality of openings along one of the circumference and the radius such that in each of the first plurality of openings, a portion of the second web and a portion of the corresponding one of the second plurality of openings are exposed.

12. The vehicle according to claim 11, wherein the plurality of stator laminations includes a third stator lamination, including a third web and a third plurality of openings extending through the third web spaced about the circumference, the third plurality of openings defining a third portion of the coolant passage.

13. The vehicle according to claim 12, wherein the third stator lamination is stacked upon the second stator lamination with each of the third plurality of openings being offset relative to corresponding ones of the second plurality of openings along one of the circumference and the radius such that in each of the third plurality of openings, a portion of the second web and a portion of the corresponding one of the first plurality of openings and the second plurality of openings are exposed.

14. The vehicle according to claim 13, wherein each of the third plurality of openings are substantially aligned with corresponding ones of the first plurality of openings.

15. The vehicle according to claim 14, wherein the plurality of stator laminations includes a fourth stator lamination, including a fourth web and a fourth plurality of openings extending through the fourth web spaced about the circumference, the fourth plurality of openings defining a fourth portion of the coolant passage.

16. The vehicle according to claim 15, wherein the fourth stator lamination is stacked upon the third stator lamination with each of the fourth plurality of openings being offset relative to corresponding ones of the third plurality of openings along one of the circumference and the radius such that in each of the fourth plurality of openings, a portion of the third web and a portion of the corresponding one of the third plurality of openings, the first plurality of openings and the second plurality of openings are exposed.

17. The vehicle according to claim 16, wherein each of the fourth plurality of openings are substantially aligned with corresponding ones of the second plurality of openings.

18. The vehicle according to claim 15, wherein the first stator lamination defines a first stator lamination group including a first number of stator laminations, the second stator lamination defines a second stator lamination group including a second number of stator laminations, the third stator lamination defines a third stator lamination group including a third number of stator laminations, and the fourth stator lamination defines a fourth stator lamination group including a fourth number of stator laminations.

19. The vehicle according to claim 18, wherein the second number of stator laminations is less than the first number of stator laminations, the third number of stator laminations is less than the second number of stator laminations, and the fourth number of stator laminations are less than the third number of stator laminations.

20. The vehicle according to claim 19, wherein the stator includes a first axial end, a second axial end, and a central portion having a coolant inlet fluidically connected to the coolant passage, the first stator lamination group being arranged at the coolant inlet, the second stator lamination group being arranged directly adjacent to the first stator lamination group, the third stator lamination group being arranged directly adjacent the second stator lamination group, and the fourth stator lamination group being arranged at one of the first axial end and the second axial end.
